(19) United States
(12) Patent Application Publication
(10) Pub. No.: US 2012/0221445 A1
(43) Pub. Date: Aug. 30, 2012

(54) METHOD AND APPARATUS FOR DETECTING DUPLICATE ACCOUNTING RECORDS IN DISTRIBUTED NETWORK

(75) Inventor: Ranjan Sharma, New Albany, OH (US)

(73) Assignee: ALCATEL-LUCENT USA INC., Murray Hill, NJ (US)

(21) Appl. No.: 13/036,270

(22) Filed: Feb. 28, 2011

(51) Int. Cl. G06Q 30/00

(52) U.S. Cl. 705/30

(57) ABSTRACT

A method for processing accounting requests (ACRs) to account for service provided by a network element (NE) of a service provider network may include receiving an ACR from a NE at a charging collection function (CCF) server, the CCF server in a charging system comprising a plurality of CCF servers, the ACR representative of a corresponding portion of service provided by the NE in conjunction with a communication session served by the service provider network, determining the ACR is a potential duplicate ACR for the portion of service; and storing ACRs received by the CCF server from the NE for the communication session in a retransmission buffer for subsequent detection and reconciliation of duplicate ACRs from the NE for the communication session by the charging system. The CCF server may include a network communication module, a retransmission status module, and a storage device that includes the retransmission buffer.

### BACKGROUND

This disclosure relates to techniques for processing accounting requests (ACRs) in a charging collection function (CCF) of a charging system to account for service provided by a network element (NE) of a service provider network where the CCF is formed by a distributed network of CCF servers. The ACR processing in the CCF includes detection and reconciliation of duplicate ACRs so that a complete charging data record (CDR) for service provided by the NE during the communication session can be properly aggregated. For example, this disclosure describes exemplary embodiments of a method and apparatus for identifying potentially duplicate ACRs from a NE of an internet protocol (IP) multimedia subsystem (IMS) service provider network for a communication session in conjunction with transmission and retransmission of the same ACR from the NE to different CCF servers. However, the methods and apparatus described herein may be used in conjunction with accounting for service provided by other types of service provider networks. As can be appreciated by those skilled in the art, various combinations of the ACR processing techniques disclosed herein can be used in conjunction with steady-state, out-of-service (OOS), and recovery from OOS operations for a given CCF.

In a service provider network, such as an internet protocol (IP) multimedia subsystem (IMS) network, for post-paid billing, a distributed charging collection function (CCF) in a charging system is formed by a plurality of CCF servers arranged in a network. The charging system is used to collect and process accounting information from the network elements (NEs) for a billing system. The NEs also may be referred to as charging trigger functions (CTFs). A communication session in the service provider network and the corresponding accounting session in the charging system begins with a start accounting request (ACR), may include zero or more interim ACRs. updates, and terminates with a stop ACR. Each CTF participating in the communication session follows the START-INTERIM-STOP sequence for each session. None of the CTFs participating in the communication session know if other CTFs are also participating and sending ACRs to a CCF server.

The NEs (i.e., CTFs) provide ACRs to CCF servers when a configured charging trigger occurs on the NE. For example, the ACRs and other communications between the CTFs and CCF servers may comply with the Diameter base protocol. See, e.g., RFC 3588 Diameter Base Protocol, September 2003, by Calhoun et al., the contents of which are fully incorporated herein by reference, for additional information on the Diameter base protocol. Under normal circumstances, each ACR is acknowledged by the corresponding CCF server sending an accounting answer (ACA) to the corresponding NE (i.e., CTF). Upon receipt of the ACA, the NE (i.e., CTF) removes the corresponding ACR from its queue of ACRs to be delivered and proceeds to send the next ACR in the queue to the CCF server.

RFC 3588 Diameter Base Protocol also defines a failover strategy whereby a Diameter client (e.g., NE (i.e., CTF)) can time out waiting for the ACA acknowledging that the ACR was received. Upon sending an ACR, the CTF starts a timer. If the CTF receives an ACA from the corresponding CCF server before the timer expiry, the CTF reliably knows that the ACR was delivered successfully and is registered with the CCF server. The CTF removes the acknowledged ACR from its processing queue and sends the next ACR and re-initializes the timer. This process continues for all session accounting.

However, if the acknowledgment (i.e., ACA) for the last sent ACR is not properly received, the CTF is required to re-send the ACR to the CCF of the charging system. Non-receipt of the acknowledgement at the sending NE (i.e., CTF) can be caused by one or more of the following: i) the CCF server that received the ACR became out-of-service (OOS), ii) the CCF server that received the ACR encountered an overload problem and did not respond, iii) the CCF server that was supposed to receive the message actually went down prior to the reception of the message, iv) the CCF server responded with a positive acknowledgment (i.e., ACA), however, the service provider network malfunctioned in delivering the ACA to the sending NE (i.e., CTF), v) the CCF server never received the ACR due to a service provider network or charging system malfunction (i.e., the CCF server had no knowledge of the ACR), and vi) the sending NE (i.e., CTF) malfunctioned before registering the ACA and before removing the corresponding ACR from its queue of messages to be sent.

In other words, a CTF (i.e., NE) sends an ACR to the CCF server and starts a timer. If the CCF server responds to the ACR within this timer with an ACA, the CTF (i.e., NE) understands that the ACR has been reliably delivered to the CCF server. However, in cases where the ACA does not reach the CTF (i.e., NE) within the timer expiry, the CTF (i.e., NE) retransmits the ACR to an alternate CCF server with an indication that the ACR being sent is potentially a duplicate. On a CCF server, when an ACR arrives with the ‘possibly duplicate’ indication, the CCF must ascertain if the ACR is indeed a duplicate of an ACR that was received by another CCF. The ‘possibly duplicate’ indication may be provided by setting a command flag in the Diameter header of the ACR, such as the T-bit, for a potentially duplicate ACR. If the original or previous ACR and the retransmitted ACR are both sent to the same CCF, duplicate detection is a matter of comparing two locally available ACRs. However, if the retransmitted ACR is sent to a different CCF server (e.g., for reasons of overload or failover), then the duplicate detection would require two ACRs on different CCF servers to be compared. Moreover, as an added complication, the CCF server that receives the retransmitted ACR does not know which of the CCF servers received the original or previous ACR. In short, the issue may be characterized as “how does a CCF server that receives a re-transmitted ACR know where to look for a possible duplicate ACR?.”

In all these cases, RFC 3588 states that the sending NE (i.e., CTF) should retransmit the ACR to an alternate peer CCF server with a command flag set to declare the retransmitted message is a potentially duplicate message. It is up to the receiving entity in the charging system (e.g., secondary CCF server) to handle the retransmitted message and define its processing for any of the error conditions stated above. Further, the standards (e.g., RFC 3588) call for maintaining the same value for the End-to-End Identifier (E2EI) field in the Diameter header of the initial and retransmitted ACRs. The Origin Host field (i.e., AVP 264) is a mandatory attribute-value pair (AVP) in the Diameter header of ACRs. The Original Host field is a DiameterIdentity data type that identifies the endpoint that originated the ACR. The E2EI value is guaranteed to be unique for at least 4 minutes.

In several of the error cases, it is likely that the failure is caused by a CCF server going OOS. In most of the cases, it is likely that the CTF would execute a failover strategy and choose an alternate peer CCF server to receive the retransmitted message. This raises the problem of having to reconcile potentially duplicate messages that were sent to two different CCF servers from among a cluster of servers in the charging system. Since a failover CCF server (i.e., alternate peer or secondary CCF server) is selected by a load distributor/load balancer which is outside the realm of the CCF, the algorithm for selection of the failover CCF server cannot be reliably predicted or assumed at the “failed over to” CCF server (i.e., succeeding CCF server) that handles the retransmitted message and subsequent messages. Especially difficult would be the scenario when the CCF server loads are considered when selecting a failover CCF server. This is a dynamic and non-deterministic situation. Therefore, a succeeding CCF server cannot easily determine the identity of another CCF server that handled a previous transmission of the retransmitted ACR session and earlier ACRs for the communication session.

Also, a brute force search of retransmitted messages from across the plurality of CCF servers is not advisable due to the potential for consuming too many CPU cycles in a non-core activity. The problem is amplified by the fact that at any moment, there can be thousands of communication sessions in progress that encounter the same problem, which makes the associated search 1000× more severe.

The problem of duplicate ACR detection is recognized in the standards (e.g., RFC 3588) and some guidelines are available for duplicate ACR detection. For example, see Diameter Duplicate Detection Cons. <draft-avseren-dime-dupcons-00.txt>, Aug. 30, 2006, by Asveren, Ulticom Inc., available at http://tools.ietf.org/html/draft-asveren-dime-dupcons-00, the contents of which are fully incorporated herein by reference.

The guidelines in the Diameter Duplicate Detection Cons document address buffering of ACRs with the T-bit not set (see Section 4.1) and buffering of ACRs with the T-bit set (see Section 4.2). However, the guidelines for buffering ACRs with the T-bit not set require the Origin-Host AVP and E2EI parameter for all ACRs received by a CCF server to be saved until it is guaranteed that no corresponding retransmission will be received. If the CCF server is unable to regenerate the exact ACA which was sent as response to the original ACR, this ACA must be saved as well. Similarly, the guidelines for buffering ACRs with the T-bit set require ACRs with T-bit set to be buffered, if the original ACR is not received because it is possible for a retransmission ACR to arrive before the corresponding original ACR. In such a case, the original ACR must be treated as the duplicate ACR. However, these guidelines require substantial buffering and do not address failover conditions in a distributed network with multiple CCF servers. They only address circumstances where the same CCF server receives the original ACR and the retransmitted ACR.

In other words, the existing guidelines do not provide an implementation hint when dealing with a multiple CCF servers in a distributed network deployment of the charging system. For example, in a distributed network of multiple CCF servers, the following scenario may occur: i) CCF1 receives ACRs for a communication session from 8 AM-8:30 AM and ii) CCF2 receives ACRs for the communication session, starting with a potentially duplicate ACR, from 8:15-8:45 AM. Both CCF servers process the ACRs and both provide a charging data record (CDR), marked as an “Incomplete CDR” as defined in the standards (e.g., RFC 3588):

For example, an incomplete CDR may be identified by the following ASN.1 definition:

Incomplete-CDR-Indication ::= SET
{

| | |
|---|---|
| aCRStartLost | [0] BOOLEAN, -- TRUE if ACR[Start] was lost, |
| | FALSE otherwise |
| aCRInterimLost | [1] ACRInterimLost, |
| aCRStopLost | [2] BOOLEAN -- TRUE if ACR[Stop] was lost, |
| | FALSE otherwise |
| } | |

However, as a result of this split, with two incomplete CDRs cover a session overlap, the billing mediation system is unable to make necessary adjustments to avoid double partial billing for the period between 8:15 AM-8:30 AM. The billing mediation is not as session-aware as the CCF. Thus, a solution to the problem may lie at the CCF layer.

A second problem arising out of a CCF server becoming OOS is that the billing mediation would receive two (or possibly more than two) incomplete CDRs that are separated by several hours. If the billing mediation layer has already processed the first incomplete CDR, there is no way it can handle the second incomplete CDR in a satisfactory manner. This would invariably result in billing the end-user twice for at least a portion of the same session. As network operators are trying to contain the rising operational costs of running the service provider networks, this situation raises another problem that requires attention.

For these and other reasons, there is a need to resolve duplicate ACR detection in a CCF of a charging system that is deployed via a distributed network of CCF servers. Based on the foregoing, a need exists for a robust mechanism for detection and reconciliation of duplicate ACRs that can used in conjunction with a CCF in a charging system formed by a distributed network of CCF servers.

### SUMMARY

In one aspect, a method for processing accounting requests in a charging system to account for service provided by a network element of a service provider network is provided. In one embodiment, the method includes: a) receiving a first accounting request (ACR) from a network element (NE) at a first charging collection function (CCF) server, the NE being in a service provider network, the first CCF server in a charging system comprising a plurality of CCF servers, the first ACR representative of a corresponding first portion of service provided by the NE in conjunction with a communication session served by the service provider network; b) determining the first ACR is a potential duplicate ACR for the first portion of service; and c) storing ACRs received by the first CCF server from the NE for the communication session in a retransmission buffer in the first CCF server for subsequent detection and reconciliation of duplicate ACRs from the NE for the communication session by the charging system.

In another embodiment, the method for processing accounting requests in a charging system to account for service provided by a network element of a service provider network includes: a) at a first charging collection function (CCF) server, determining the first CCF server has returned to service after having been out of service, the first CCF server in a charging system comprising a plurality of CCF servers, the first CCF server adapted to selectively receive accounting requests (ACRs) from a network element (NE) of a service provider network, the ACRs representative of corresponding portions of service provided by the NE in conjunction with a first communication session served by the service provider network, the first CCF server also adapted to selectively serve as a reconciliation host for detecting and reconciling duplicate ACRs for a given communication session; and b) sending an “I'm alive” message from the first CCF server to other CCF servers in the charging system to notify the other CCF servers the first CCF server is ready to detect and reconcile duplicate ACRs for communication sessions for which the first CCF server is assigned as the reconciliation host.

In another aspect, a first charging collection function (CCF) server in a charging system comprising a plurality of CCF servers is provided, the first CCF server for processing accounting requests in the charging system to account for service provided by a network element of a service provider network. In one embodiment, the first CCF server includes: a network communication module for receiving a first accounting request (ACR) from a network element (NE) of a service provider network, the first ACR representative of a corresponding first portion of service provided by the NE in conjunction with a communication session served by the service provider network; a retransmission status module in operative communication with the network communication module for determining the first ACR is a potential duplicate ACR for the first portion of service; and a storage device in operative communication with the network communication module and retransmission status module for storing ACRs from the NE for the communication session in a retransmission buffer for subsequent detection and reconciliation of duplicate ACRs from the NE for the communication session by the charging system.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an exemplary embodiment of a charging system formed by a distributed network of charging control function (CCF) servers under normal conditions;

FIG. 2 is a block diagram of the charging system of FIG. 1 with an exemplary failover condition;

FIG. 3 is a functional diagram showing exemplary embodiments of an original CCF server and an alternate peer CCF server in conjunction with an exemplary accounting request (ACR) process in relation to the failover condition of FIG. 2;

FIG. 4 is a flow chart of an exemplary embodiment of a process for processing ACRs in an exemplary CCF server to account for service provided by a network element of a service provider network;

FIG. 5, in conjunction with FIG. 4, is a flow chart of another exemplary embodiment of a process for processing ACRs in an exemplary CCF server;

FIG. 6, in conjunction with FIG. 4, is a flow chart of yet another exemplary embodiment of a process for processing ACRs in an exemplary CCF server;

FIG. 7, in conjunction with FIG. 4, is a flow chart of still another exemplary embodiment of a process for processing ACRs in an exemplary CCF server;

FIG. 8, in conjunction with FIG. 4, is a flow chart of yet still another exemplary embodiment of a process for processing ACRs in an exemplary CCF server;

FIG. 9, in conjunction with FIG. 4, is a flow chart of another exemplary embodiment of a process for processing ACRs in an exemplary CCF server;

FIG. 10, in conjunction with FIG. 4, is a flow chart of yet another exemplary embodiment of a process for processing ACRs in an exemplary CCF server;

FIG. 11 is a flow chart of another exemplary embodiment of a process for processing ACRs in an exemplary CCF server;

FIG. 12, in conjunction with FIG. 11, is a flow chart of yet another exemplary embodiment of a process for processing ACRs in an exemplary CCF server;

FIG. 13, in conjunction with FIG. 11, is a flow chart of still another exemplary embodiment of a process for processing ACRs in an exemplary CCF server; and

FIG. 14 is a block diagram of an exemplary embodiment of a CCF server of a charging system formed by a distributed network of CCF servers.

### DETAILED DESCRIPTION

Various embodiments of methods and apparatus for processing accounting requests (ACRs) in a charging collection function (CCF) of a charging system to account for service provided by a network element (NE) of a service provider network where the CCF is formed by a distributed network of CCF servers. In certain embodiments, the methods and apparatus include identifying potentially duplicate ACRs from a NE of a service provider network for a communication session in conjunction with transmission and retransmission of the same ACR from the NE to different CCF servers. In further embodiments, the methods and apparatus include detection and reconciliation of duplicate ACRs so that a complete charging data record (CDR) for service provided by the NE during the communication session can be properly aggregated. Various combinations of the embodiments of methods and apparatus disclosed herein can be used in conjunction with steady-state, out-of-service (OOS), and recovery from OOS operations for a given CCF.

As mentioned above, this disclosure provides an approach to identify and process duplicate ACRs in a distributed CCF environment of a charging system. For additional information on processing ACRs in distributed environments of a charging system, see, e.g., i) PCT Pat. App. Publication No. WO 2010/117368 to Alcatel-Lucent USA Inc. et al., published Oct. 14, 2010; ii) U.S. Pat. App. Publication No. 2010/0257077 to Cai et al., published Oct. 7, 2010; iii) U.S. patent application Ser. No. 12/877,367 to Sharma et al., Method and Apparatus for Facilitating Interim Billing for IMS Session using Time-Based Interim Accounting Message to Determine Interim Processing Trigger, filed Sep. 8, 2010; and iv) U.S. patent application Ser. No. 12/946,394 to Sharma, Method for Choosing an Alternate Offline Charging System During an Overload and Apparatus Associated Therewith, filed Nov. 15, 2010. The contents of these documents are fully incorporated herein by reference.

Previous solutions to resolving duplicate ACRs use a mediation process in a billing system to decipher two or more CDRs and make an adjustment so that the customer is presented with a single CDR. Consider the following example cases which require billing mediation.

Example 1 occurs when an overload at a CCF server causes a failover to an alternate peer CCF server. The initial CCF server processing results in CDR1 (Subscriber-A Duration 8:00 AM-8:30 AM, Data d/l: 5 MB, Data u/l: 200 KB). The alternate peer CCF server processing results in CDR2 (Subscriber-A Duration 8:15 AM-8:45 AM, Data d/l: 2 MB, Data u/l: 500 KB). With the time overlap between the CDRs, the mediation processing in the billing system cannot definitively provide a single CDR that correctly states the bandwidth consumed for the duration of the call. Under these circumstances, the mediation processing usually takes a conservative approach and only presents CDR1 to the customer to avoid any possibility of duplicate billing. However, the consequence of this approach is typically revenue leakage because, if any portion of CDR2 is based on duplicate ACRs, it is more than likely only a small portion. Moreover, there are several CCF server failover scenarios that do not result in duplicate billing because they do not produce duplicate ACRs.

Example 2 is a failover to an alternate peer CCF server that is caused by an initial CCF server going OOS. In this case, the first CCF server fails and the second CCF server handles ACR processing for the rest of the communication session. At the end of the communication session, the second CCF server provides a CDR to the billing system that includes the corresponding stop ACR, but it is an incomplete CDR if it does not include the corresponding start ACR. At this point, the options for billing mediation are to: a) wait till the rest of the communication session is summarized by the first CCF server when it comes back “in service” (IS) or b) bill the communication session out using only the incomplete CDR. Given thousands of communication sessions in progress at any time, billing mediation typically follows the latter approach (“b”) to avoid any build-up on its servers due to waiting for other CDRs for the communication session. For example, the wait would be the corresponding CCF server that is OOS comes back IS and finishes processing its ACRs for the communication session. An additional problem occurs when the CDR from an OOS CCF server shows up after the CCF server is back IS because billing mediation has no way of correlating the billing information in the later CDR with the previous CDR. If both CDRs are billed, any overlap billing would most likely result in customer dissatisfaction and increased operational costs (CSR calls). Typically, the billing system resolves this scenario by not billing the later incomplete CDRs. Again, the consequence of this approach is typically revenue leakage.

A charging system with a distributed network of CCF servers may use an ACR processing technique to resolve failover scenarios resulting in potentially duplicate ACRs that detects and reconciles duplicate ACRs in the charging system before charging information is provided to the billing system. For example, in one embodiment, upon recognizing a potentially duplicate ACR, the receiving CCF server may put related ACRs in another table separate from the table used for normal workflow. The table with the potentially duplicate ACR can be processed separately and differently from ACRs in the normal workflow. All ACRs from the same NE pertaining to the communication session that was ‘tainted’ via the potentially duplicate ACR are also put in the separate table for special processing.

Upon receiving a signal or recognizing that participation in the accounting session by the CCF server has finished, the CCF server provides a disposition on the ACRs in the separate table by either a) assuming the role of a reconciliation and correlation host or b) determining another CCF server is designated as the host for reconciliation and correlation for this communication session and writing the ACRs from the separate table into a similar table on the designated host. In further embodiments, if a primary host for reconciliation and correlation of the communication session is not available, yet another CCF server that is designated as a secondary host may be determined for further processing of the tainted ACRs. If the secondary host for the communication session is also unavailable, the CCF server may hold the tainted ACRs in the separate table for a predetermined interval and wait for the primary or secondary host to be revived.

Assuming ACR processing is able to continue, the tainted ACRs pertaining to the same NE and same communication session are all sent to the chosen reconciliation host for processing. The reconciliation host provides for duplicate ACR detection and eliminates redundant (i.e., duplicate) ACRs. The reconciled ACRs associated with the same NE are aggregated and correlated with ACRs from other NEs for the same communication session by the correlation host to form CDRs for the communication session suitable for normal processing by the billing system.

For example, there are algorithms in place for distributed CCF servers to separately determine which CCF server is designated as reconciliation and correlation host (including primary and secondary hosts) on a per-communication session basis to distribute the ACR processing load. Each algorithm (e.g., reconciliation host, correlation host, primary host, secondary host, etc.) is a function of a unique communication session identification parameter within the corresponding ACR. For example, an IMS charging identifier (ICID) parameter is the unique communication session identification parameter for ACRs from an IMS network service provider. If the same CCF server is to serve as reconciliation and correlation host, the function is the same (e.g., f(ICID)). If different CCF servers are to serve as reconciliation host and correlation host, the functions are different (e.g., fᵣ(ICID), f_{c}(ICID)). Similarly, if primary and secondary hosts are designated additional functions may be used (e.g., fₚᵣ(ICID), fₛᵣ(ICID), f_{pc}(ICID), f_{sc}(ICID)). All CCF servers in the distributed network use the same algorithms to determine the corresponding host on a per-communication session basis. For additional information on such algorithms, see PCT Pat. App. Publication No. WO 2010/117368 to Alcatel-Lucent USA Inc. et al., published Oct. 14, 2010.

The ACR processing techniques described herein avoid a brute-force approach for a given CCF server to locate ACRs for the same communication session that were processed and stored on multiple CCF servers. Rather, ACRs for the same communication session on multiple CCF servers find their way to the designated host for reconciliation and correlation. The CCF server designated as the host processes the ACRs for correct accounting and the correlation host provides a single ratable CDR to the billing system with no need for any further adjustments or guess work at the billing mediation layer.

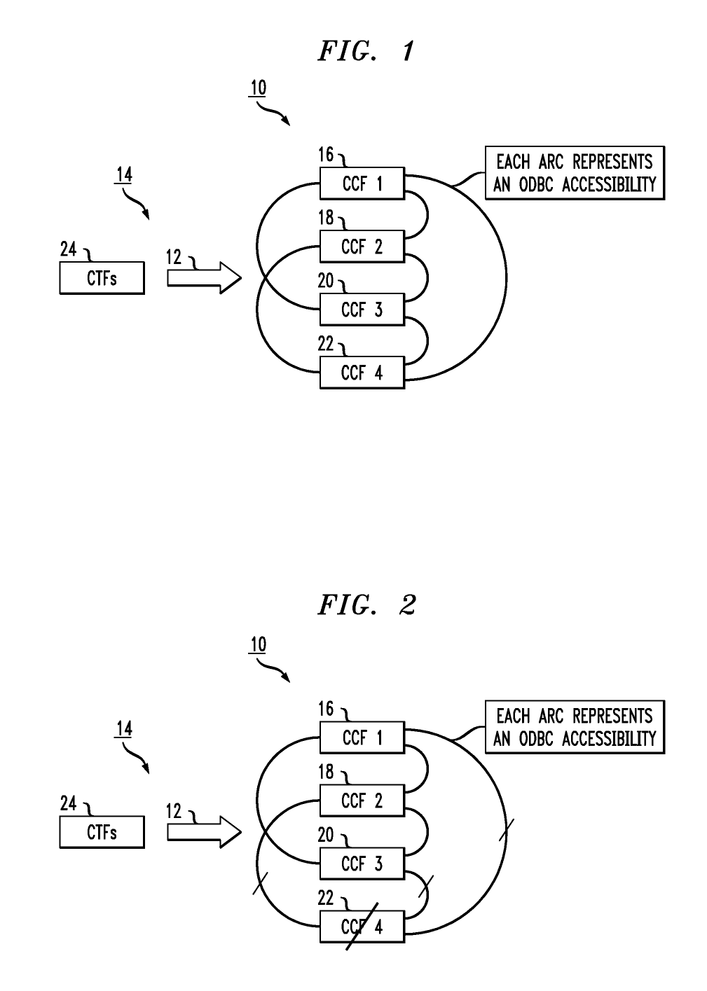

Referring now to the drawings wherein the showings are for purposes of illustrating the exemplary embodiments only and not for purposes of limiting the claimed subject matter, FIG. 1 depicts normal conditions for an exemplary embodiment of a charging system 10 formed by a distributed network of CCF servers for processing ACRs 12 for communication sessions from a service provider network 14. The exemplary charging system 10 including a first CCF server (CCF1) 16, a second CCF server (CCF2) 18, a third CCF server (CCF3) 20, and a fourth CCF server (CCF4) 22. The service provider network 14 including a plurality of CTFs 24 (i.e., NEs).

In the steady-state, the CTFs 24 can send ACRs 12 to any CCF server (16, 18, 20, 22). The receiving CCF server (e.g., 16) normally processes the ACRs 12 up to and including aggregation to form a complete CDR for the corresponding CTF 24 for a corresponding communication session served by the service provider network 14. Then, the CCF server (e.g., 16) determines which CCF server is designated as correlation host for the communication session based on f(Key). The (Key) for determining the correlation host is a unique communication session identifier, such as ICID, which is guaranteed to be unique for a period of at least one month. The CCF server (e.g., 16) sends the aggregated ACRs (i.e., the complete CDR) associated with service provided by the NE to CCF server designated as the correlation host via, for example, an open database connectivity (ODBC) write operation. Generally, the correlation processing is equally distributed among the distributed CCF servers.

With reference to FIG. 2, assume the fourth CCF server (CCF4) 22 experiences an overload condition or goes OOS. This affects communication sessions for which ACR processing from one or more CTFs was being handled at CCF4 22. In addition, it either delays processing of ACRs and CDRs for communication sessions for which CCF4 22 was designated as the reconciliation, aggregation, and/or correlation host or forces other CCF servers processing ACRs for communication sessions for which CCF4 22 was designated as the primary host to determine a secondary host for reconciliation, aggregation, and/or correlation in place of CCF4 22.

The corresponding CTF 24 recognizes the CCF4 22 outage after sending an ACR because CCF4 22 would not be able to acknowledge receiving the ACR with an ACA within the timer started at the CTF. Upon recognizing the CCF4 22 outage, the CTF 24 initiates a failover to an alternate peer CCF server (e.g., CCF2 18) per RFC 3588. This entails re-sending (i.e., retransmitting) the ACR that was not acknowledged to a different CCF server (e.g., CCF2 18). Per RFC 3588, the T-bit in the command flags in the header is set in the retransmitted ACR to indicate the ACR is a potentially duplicate ACR and the values in the End-to-End Identifier (E2EI) field and the Origin-Host parameter (AVP 264) of the header are the same as the original ACR. In other words, the T-bit being set indicates the ACR is “tainted” and the Origin-Host and E2EI combination can be used to identify matching ACRs as duplicates.

As described in RFC 3588, the Diameter message header includes the following fields:

| | |
|---|---|
| Version | Message Length |
| command flags | Command-Code |

```
        Application-ID
    Hop-by-Hop Identifier
    End-to-End Identifier
    AVPs ...
```

For example, the command flags include eight bits (e.g., R P E T r r r r) with the fourth bit designated as the T-bit and set to one (1) in case of retransmission of a potentially duplicate ACR. The command flags are further identified as follows: i) R (if set, the message is a Request, otherwise, the message is an Answer); ii) P (denotes the message is proxiable); iii) E (denotes the message contains a protocol error (error message)); iv) T (re-transmitted, potentially duplicate message); and v) r (reserved bits).

The E2EI field is an unsigned parameter with 32 bits. The high order twelve (12) bits may contain the low order twelve (12) bits of current time and the low order 20 bits may contains a random value. The sending entity (i.e., NE or CTF) must include a unique E2EI for each ACR. Each E2EI must locally remain unique for at least 4 minutes. The responding entity (i.e., CCF server) must reflect the same E2EI value in the ACA to the sending entity. The Origin-Host parameter (AVP 264) is a DiameterIdentity data type and a mandatory AVP in all ACRs. In general, a CCF server can detect duplicates by examining the value in the Origin Host field (i.e., AVP 264) in combination with the value in the E2EI field of the ACRs. Implementations can generally easily exceed the 4-minute period because there are twelve (12) bits available for the purpose of unique identification.

Appendix C of RFC 3588 provides the guidelines that the receiving CCF server can limit the extent of search for duplicate ACRs within a configurable duplication time window backward and forward. During failover, the original ACR may be received by the previous CCF server after the retransmitted ACR is received by the subsequent CCF server. This may be caused by a variety of circumstances, such as different delays on different communication paths taken by the corresponding ACRs. Nevertheless, under the distributed network architecture, original and retransmitted ACRs may be on different CCF servers and the CCF server receiving the retransmitted message has no way of knowing which CCF server was the original destination or whether it actually received the original ACR.

The OOS CCF 4 22 may cause the load distribution strategy in the network to select CCF 2 18 as the alternate peer CCF server for receiving the retransmitted ACR and subsequent ACRs based on the factors that are employed to select an alternate peer in case of CCF server failure. The load distribution strategy may also result in selection of CCF1 16 or CCF3 20. Thus, the description that follows is generic and not tied to a specific CCF server. Additionally, in relation to ACR processing for detection and reconciliation of duplicate ACRs, the mean time to repair (MTTR) a CCF server that is OOS of T hours (e.g., 0.75 hours, 2 hours, or any actual or predicted MTTR value) may be considered.

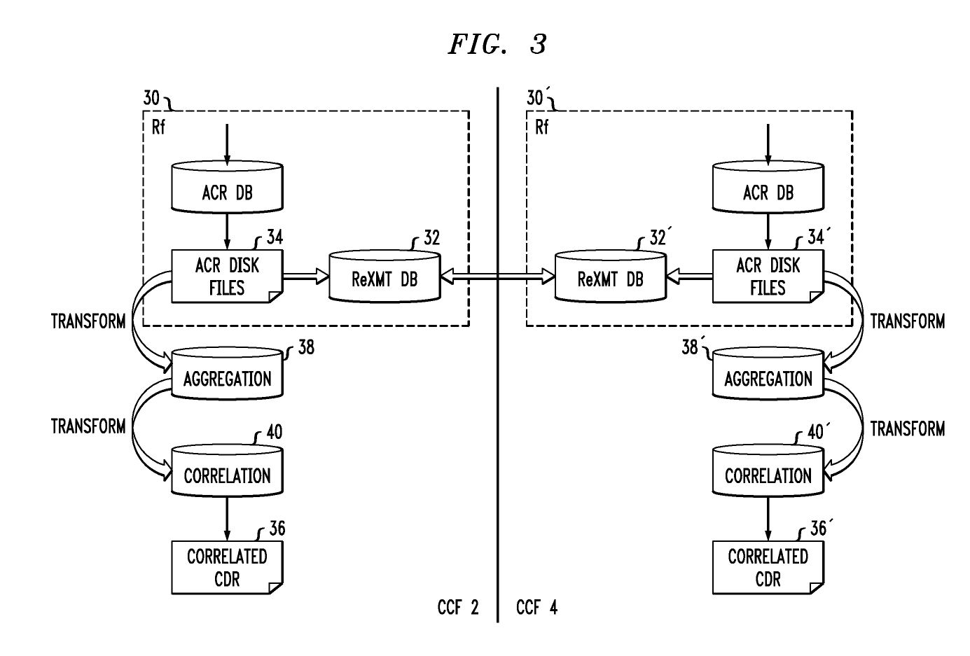

With reference to FIG. 3, for an ACR received by an alternate peer CCF server 30, the T-bit is set and the ACR is stored in a retransmit database 32 (ReXMT DB) at the alternate peer CCF server 30. The retransmitted ACR may be a start ACR, an interim ACR, or a stop ACR that was not properly acknowledged by the CCF server 30′ previously designated to receive ACRs from the corresponding CTF for the corresponding communication session. The alternate peer CCF server 30 detects that T-bit is set and moves the retransmitted ACR from the ACR disk files 34 along the normal ACR processing path to the ReXMT DB 32. The T-bit being set also indicates that this ACR is the first ACR received from the corresponding CTF for the corresponding communication session. The corresponding CTF continues sending ACRs to the alternate peer CCF 30 until another failover condition occurs or until a stop ACR is received indicating the end of the communication session. The T-bit is not set in the subsequent ACRs received by the alternate peer CCF server 30. Nevertheless, the alternate peer CCF server 30, continues moving the subsequent ACRs from the corresponding CTF for the corresponding communication session from the ACR disk files 34 to the ReXMT DB 32.

Similarly, the CCF server 30′ that was previously designated to receive ACRs from the corresponding CTF for the corresponding communication session can detect a missed interim time-based ACR or a missed stop ACR from the corresponding CTF for the corresponding communication session. For example, after at least a start ACR for the corresponding communication session is received by the CCF server 30′ from the corresponding CTF, the CCF server 30′ can determine a subsequent ACR was not received from the corresponding CTF for the corresponding communication session within a predetermined time after a previous ACR from the corresponding CTF for the corresponding communication session. The predetermined time being greater than an expected time interval, such as an accounting-interim-interval (All), between time-based ACRs from the corresponding CTF for the corresponding communication session accounting. See, e.g., RFC 3588 for additional information regarding the All. After detecting a missing interim time-based ACR or a missing stop ACR, the CCF server 30′ moves the ACRs from the corresponding CTF for the corresponding communication session from ACR disk files 34′ to a ReXMT DB 32′ at the CCF server 30′. For example, the CCF server 30′ can identify previously received ACRs from the corresponding CTF for the corresponding communication session by matching the values for the combination of Origin Host field (i.e., AVP 264) and the unique communication session identification (e.g., ICID) field. For normal ACR processing, including normal aggregation and correlation processing, the ACRs remain in the ACR disk file 34′ and follow the normal processing track to produce correlated CDRs 36′ without using the ReXMT DB 32′.

Based on distributed database (DDB) scheme for reconciliation, aggregation 38′, and correlation 40′, there can be primary and secondary CCF servers designated for reconciliation, aggregation, and correlation of these records. The same CCF server can be designated for reconciliation, aggregation, and correlation. Alternatively, multiple CCF servers can be designated for reconciliation, aggregation, and correlation in any suitable combination. The CCF server designated for reconciliation, aggregation, and correlation can be determined, for example, as a function of unique communication session identification field, such as the ICID field. For example, fₚ(ICID) may be used to determine the CCF server designated as the primary reconciliation, aggregation, and correlation host and fₛ(ICID) may be used to determine the CCF server designated as the secondary host. If the primary host is IS, the CCF servers 30, 30′ write the ACRs stored in the corresponding ReXMT DBs 32, 32′ to an ReXMT DB at the primary host.

If the primary host does not acknowledge receipt of the ACRs from the CCF servers 30, 30′, the CCF servers 30, 30′ write the ACRs stored in the corresponding ReXMT DBs 32, 32′ to an ReXMT DB at the secondary host. If the secondary host does not acknowledge receipt of the ACRs, the CCF servers 30, 30′ retain the ACRs. As described, the ReXMT DB would show a message build-up if both the primary and secondary hosts are OOS. The CCF servers 30, 30′ may release or move the ACRs from the ReXMT DB 32, 32′ to a lost ACR storage area after a predetermined time or after a predetermined maximum fill factor for the ReXMT DB 32, 32′ is exceeded.

Regarding the build-up or holding of ACRs in a given ReXMT DB, the CCF server holding the ACRs may be the designated reconciliation host and waiting for a portion of ACRs from the corresponding CFT for the corresponding communication session from another CCF server that is currently OOS. Alternatively, the designated reconciliation host for the corresponding communication session may be OOS and the CCF server holding the ACRs is waiting for the reconciliation host to come back IS. It is also possible that the CCF server holding the ACRs is simply OOS and waiting to come back IS before transferring the ACRs to the reconciliation host.

In the first example, the CCF server holding the ACRs is the reconciliation host for the communication session, but it is missing the start ACR or the stop ACR (or both the start and stop ACRs) from the corresponding CTF for the communication session. Here, the CCF server cannot commence execution of the reconciliation process until both start and stop ACRs from the corresponding CTF are stored in the ReXMT DB. Execution of the reconciliation process is a precursor to aggregation of ACRs from the corresponding CTF to form a CDR for service by the corresponding CTF as well as correlation of CDRs for each CTF serving the corresponding communication session to form a consolidated CDR for the billing system.

In the second example, the CCF server holding the ACRs is not the correlation host, but it cannot send its portion of the ACRs from the corresponding CTF for the corresponding communication session to the designated reconciliation host because the designated host is currently OOS. If the charging system uses primary and secondary reconciliation hosts, this condition results when both primary and secondary reconciliation hosts are OOS. If only the primary reconciliation host is OOS, the CCF server does not have to hold the ACRs and can send them on to the secondary host.

In conjunction with reconciliation hosts being OOS, a CCF server implementing a process for detecting and reconciling duplicate ACRs may also use a mechanism is to let other CCF servers know when it is back IS after having been OOS. The CCF server may also have a predetermined threshold or an algorithm for defining an upper time bound to hold the ACRs in the ReXMT DB such that ACRs are not held indefinitely. For example, an initial value of two times MTTR for the corresponding CCF server may be chosen as the threshold or as the algorithm.

As mentioned above, in the steady-state, a given CCF server may be holding ACRs in its ReXMT DB because it is waiting either to send or to receive ACRs that would result in completed reconciliation processing regarding duplicate ACR detection for subsequent aggregation of ACRs from the corresponding CTF for the corresponding communication session in a CDR. If the CCF server in question is the reconciliation host, it is waiting for the remaining ACRs from the corresponding CTF for the corresponding communication session to be sent to ReXMT DB by another CCF server that is apparently OOS. Otherwise, the CCF server in question is waiting for the reconciliation host to come back IS, so that the ACRs being held can be sent to the CCF server designated for duplicate ACR detection as the reconciliation host and further aggregation/correlation processing by the charging system.

In either case, a CCF server that implements a process for detection and reconciliation of duplicate ACRs may include an audit process the operates in conjunction with the ReXMT DB. The audit process may use a configurable timer and/or a fill factor for the ReXMT DB such that ACRs in the ReXMT DB would be deleted or moved to a lost ACR storage area after X hours in the ReXMT DB or until the ReXMT DB is Y % full (e.g., another configurable parameter, such as 80%), whichever occurs earlier. This means that ACRs in the ReXMT DB can wait for approximately X hours for the recovery of the an OOS CCF server that is designated as the reconciliation host.

When the OOS CCF server is revived, it would first process its own ReXMT DB using the audit process. For messages in the ReXMT DB that are older than X hours, it is likely that these ACRs are stale and would result in incomplete CDRs in any case. Sending such ACRs to another CCF server for reconciliation or waiting for the complementary ACRs for portions of service provided by the corresponding CTF for the corresponding communication session from other CCF servers would be futile. Thus, the audit process can move these ACRs from the ReXMT DB to a “lost” DB.

For remaining ACRs in the ReXMT DB, there may be a mix of ACRs from various CTFs and associated with various communication sessions where the revived CCF server is either the reconciliation host or holding corresponding ACRs until the CCF server designated as the reconciliation host is back IS. The revived CCF server can determine the reconciliation host as a function of the unique communication session identifier in the ACR (e.g., f(ICID). For ACRs which the revived CCF server is not the reconciliation host, it would write the ACRs to the ReXMT DB of the CCF server designated as the reconciliation host, for example, from the f(ICID) algorithm. If there are still pending ACRs in the ReXMT DB, it can be assumed that the revived CCF server is the correlation host or that can be confirmed, for example, from the f(ICID) algorithm. Since the ACRs for missing portion of service from the corresponding CTF for the corresponding communication session could be with any of the other CCF servers in the distributed network, the revived CCF server may broadcast an “I am alive” message to the other CCF servers to notify them that it is back IS and capable of acting as a reconciliation host. The “I am alive” message would prompt the other CCF servers to send ACRs they are holding in ReXMT DBs for which the revived CCF server is designated as the reconciliation host. The “I am alive” message can be sent a configurable number of times after the CCF server recovery to compensate for any other CCF server missing the broadcast message and to further compensate for other CCF servers being OOS when the initial broadcast message was sent. At this point, the audit process at the revived CCF server is complete, all ACRs that were in the ReXMT DB when the CCF server returned to service should be dispersed, and the CCF server is ready to process ACRs under steady-state conditions.

Under steady-state conditions, the “I am alive” message broadcast is not required because CCF servers can determine if other CCF servers are OOS upon attempting to write into their ReXMT DB via acknowledgement messages or any suitable handshaking or verification mechanism. Also, CCF server are not required to actively or aggressively ask other CCF servers “Who has the records for a given communication session identifier (e.g. ICID=xyz)?” which would create a lot of network traffic and processing load. Instead, the process for detection and reconciliation of duplicate ACRs uses a “good citizens” approach in which each CCF server may forward ACRs that belong to a designated reconciliation host which may also serve as aggregation and correlation hosts to facilitate processing ACRs and CDRs through to consolidated CDRs for communication sessions for the billing system.

The CCF server designated as the reconciliation host can implement any suitable methodology for detecting and reconciling duplicate ACRs down to a single ACR for the corresponding portion of service provided by the corresponding CTF for the corresponding communication session. For example, the duplicate detection methodology is applied to a set of ACRs associated with a corresponding CTF and corresponding communication session may be used to identify potentially duplicate ACRs, such as where the T-bit in the ACR is set. The process may continue by examining the Origin-Host and E2EI combinations in a group of ACRs to detect ACRs that are identical to each other (i.e., duplicates). The reconciliation process also eliminates duplicate ACRs such that a single ACR for the corresponding portion of service from the corresponding CTF for the corresponding communication session is retained. The duplicate messages may be silently discarded or logged separately for statistical purposes.

In summary, the various embodiments of methods and apparatus for detection and reconciliation of duplicate ACRs disclosed herein provides a deterministic way to address a distributed processing architecture for the CCF in the charging system when attempting to detect duplicate ACRs. Another feature is that the determination can be characterized as a just-in-time duplicate determination because it is carried out at the CCF server designated as the reconciliation host. Moreover, the same CCF server may be designated as reconciliation, aggregation, and correlation host for the corresponding communication session. The various embodiments also provide for delayed determination of duplicate ACRs in view of a logical timing constraint, such as two time MTTR for the corresponding CCF server. This provides a chance for the failed CCF server to come around and provide the ACRs for the missing portion of service provided by the corresponding CTF for the corresponding communication session. The process uses an intelligent approach to predict the reconciliation host that performs the duplicate detection from among the distributed CCF servers. The reconciliation host concept avoids a brute force search for ACRs that may be distributed among multiple CCF servers due to failover conditions.

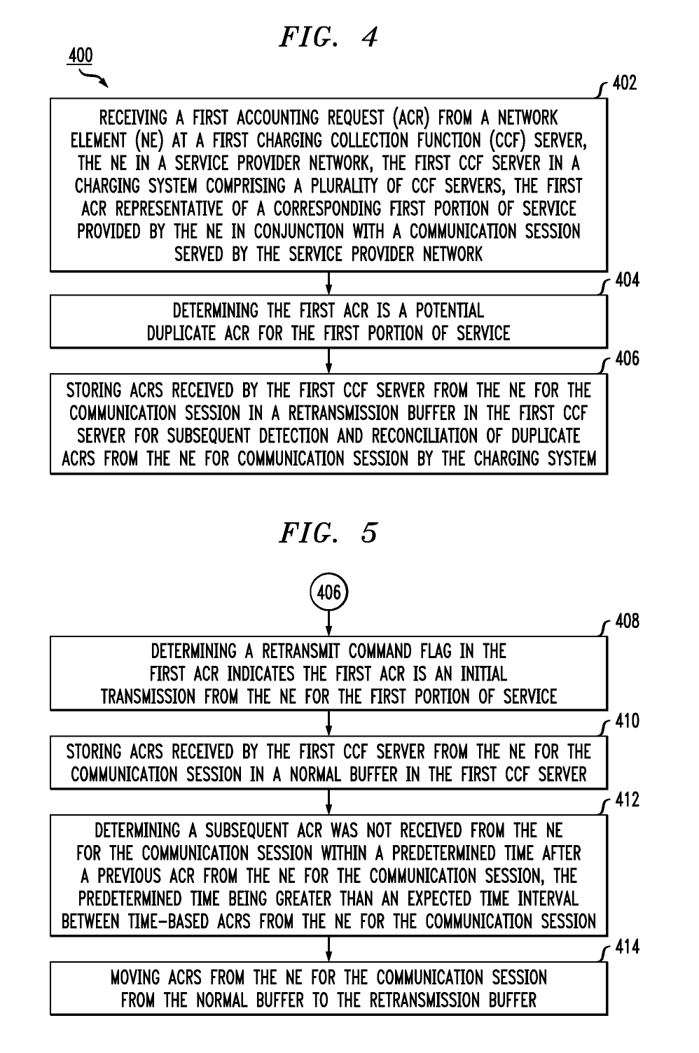

With reference to FIG. 4, an exemplary embodiment of a process 400 for processing accounting requests in a charging system to account for service provided by a network element of a service provider network begins at 402 where a first ACR is received from a NE at a first CCF server. The NE being in a service provider network. The first CCF server being in a charging system comprising a plurality of CCF servers. The first ACR representative of a corresponding first portion of service provided by the NE in conjunction with a communication session served by the service provider network. Next, the process determines the first ACR is a potential duplicate ACR for the first portion of service (404). At 406, ACRs received by the first CCF server from the NE for the communication session are stored in a retransmission buffer in the first CCF server for subsequent detection and reconciliation of duplicate ACRs from the NE for the communication session by the charging system.

With reference to FIGS. 4 and 5, in another exemplary embodiment of the process 400, the determining in 404 includes determining a retransmit command flag in the first ACR indicates the first ACR is an initial transmission from the NE for the first portion of service (408). At 410, ACRs received by the first CCF server from the NE for the communication session are stored in a normal buffer in the first CCF server. Next, the process determines a subsequent ACR was not received from the NE for the communication session within a predetermined time after a previous ACR from the NE for the communication session (412). The predetermined time being greater than an expected time interval between time-based ACRs from the NE for the communication session. At 414, the storing in 406 includes moving ACRs from the NE for the communication session from the normal buffer to the retransmission buffer.

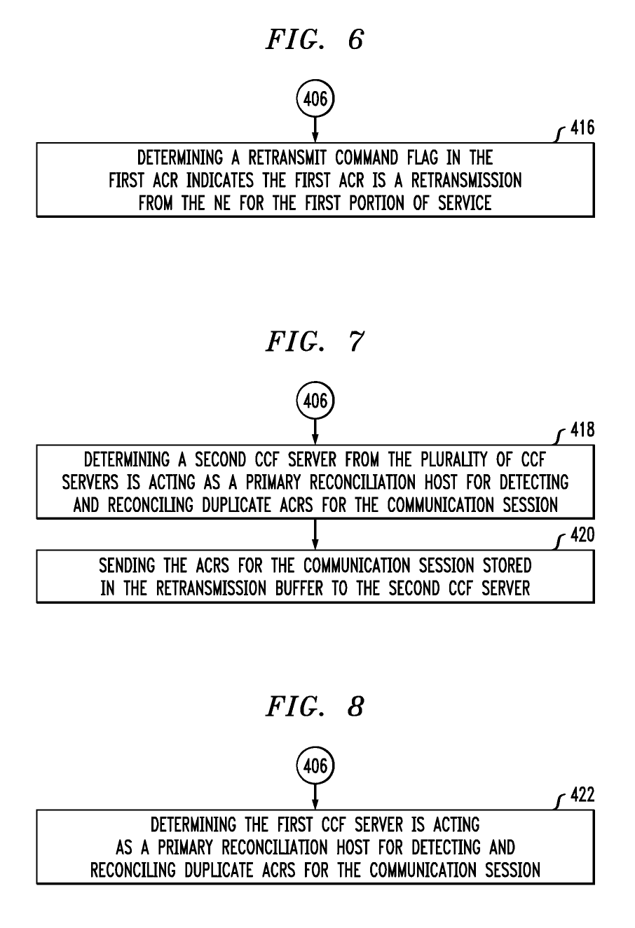

With reference to FIGS. 4 and 6, in yet another exemplary embodiment of the process 400, the determining in 404 includes determining a retransmit command flag in the first ACR indicates the first ACR is a retransmission from the NE for the first portion of service (416).

In a further embodiment, the storing in 406 includes storing the first ACR and subsequent ACRs received from the NE for the communication session in the retransmission buffer.

In an alternate further embodiment, the determining in 404 includes determining a subsequent ACR was not received from the NE for the communication session within a predetermined time after a previous ACR from the NE for the communication session. In this further embodiment, the predetermined time is greater than an expected time interval between time-based ACRs from the NE for the communication session.

With reference to FIGS. 4 and 7, in still another exemplary embodiment, the process 400 includes determining a second CCF server from the plurality of CCF servers is acting as a primary reconciliation host for detecting and reconciling duplicate ACRs for the communication session (418) At 420, the process sends the ACRs for the communication session stored in the retransmission buffer to the second CCF server.

In a further embodiment, the process also includes receiving an acknowledgement message from the second CCF server at the first CCF server. The message acknowledging receipt of the ACRs sent to the second CCF server by the first CCF server. In this further embodiment, the ACRs for the communication session stored in the retransmission buffer are deleted in conjunction with receipt of the acknowledgement message from the second CCF server.

In an alternate further embodiment, the process also includes determining an acknowledgement message was not received from the second CCF server within a predetermined time after the ACRs were sent to the second CCF server. In this further embodiment, the process determines a third CCF server from the plurality of CCF servers is acting as a secondary reconciliation host for detecting and reconciling duplicate ACRs for the communication session. Then, the process sends the ACRs for the communication session stored in the retransmission buffer to the third CCF server.

With reference to FIGS. 4 and 8, in still yet another exemplary embodiment, the process 400 includes determining the first CCF server is acting as a primary reconciliation host for detecting and reconciling duplicate ACRs for the communication session (422).

In a further embodiment, the process also includes receiving ACRs from a second CCF server of the plurality of CCF servers for detection and reconciliation of duplicate ACRs for the communication session at the first CCF server. The ACRs from the second CCF server originating from the NE and associated with the communication session. Then, the process stores the ACRs from the second CCF server in the retransmission buffer.

In this further embodiment, the process includes determining a start ACR and a stop ACR for the communication session are stored in the retransmission buffer. Then, the process determines if multiple ACRs for the communication session stored in the retransmission buffer are representative of the first portion of service provided by the NE. Duplicate ACRs for the first portion of service are eliminated from the retransmission buffer such that a single ACR representative of the first portion of service remains in the retransmission buffer.

In a still further embodiment, the process includes aggregating the ACRs for the communication session stored in the retransmission buffer to form a CDR representative of service provided by the NE for the communication session. Then, the process determines a third CCF server from the plurality of CCF servers is acting as a correlation host for correlating CDRs for the communication session. Next, the CDR representative of service provided by the NE for the communication session is sent to the third CCF server.

In an alternate still further embodiment, the process includes aggregating the ACRs for the communication session stored in the retransmission buffer to form a CDR representative of service provided by the NE for the communication session. Then, the process determines the first CCF server is acting as a correlation host for correlating CDRs for the communication session. Next, the CDR representative of service provided by the NE for the communication session is stored in a correlation buffer in the first CCF server.

In an alternate further embodiment, the process also includes determining a predetermined time has elapsed since receiving ACRs for the communication session without having stored a start ACR and a stop ACR for the communication session in the retransmission buffer. Then, the ACRs for the communication session are moved from the retransmission buffer to a lost buffer in the first CCF server.

In another alternate embodiment, the process also includes determining a predetermined maximum fill factor for the retransmission buffer has been exceeded without having stored a start ACR and a stop ACR for the communication session in the retransmission buffer. Then, the ACRs for the communication session are moved from the retransmission buffer to a lost buffer in the first CCF server.

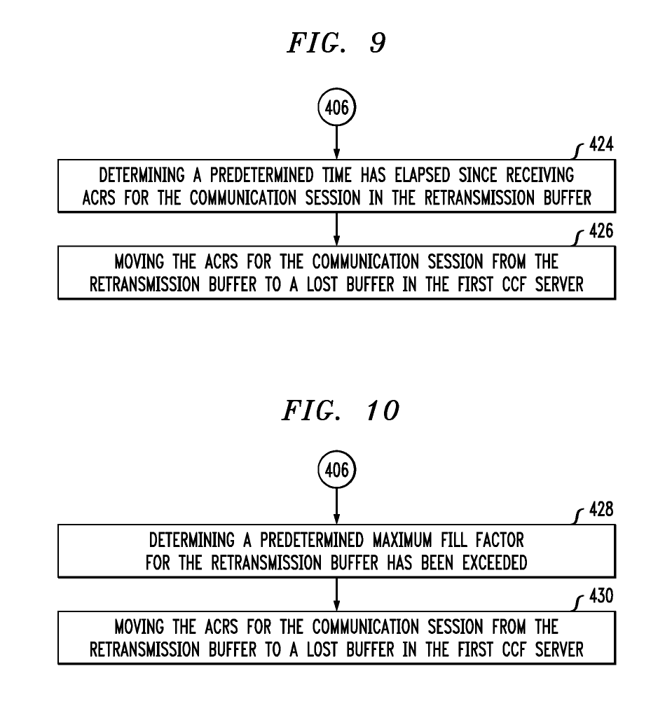

With reference to FIGS. 4 and 9, in another exemplary embodiment, the process 400 includes determining a predetermined time has elapsed since receiving ACRs for the communication session in the retransmission buffer (424). At 426, the ACRs for the communication session are moved from the retransmission buffer to a lost buffer in the first CCF server.

With reference to FIGS. 4 and 10, in yet another exemplary embodiment, the process 400 includes determining a predetermined maximum fill factor for the retransmission buffer has been exceeded (428). At 430, the ACRs for the communication session are moved from the retransmission buffer to a lost buffer in the first CCF server.

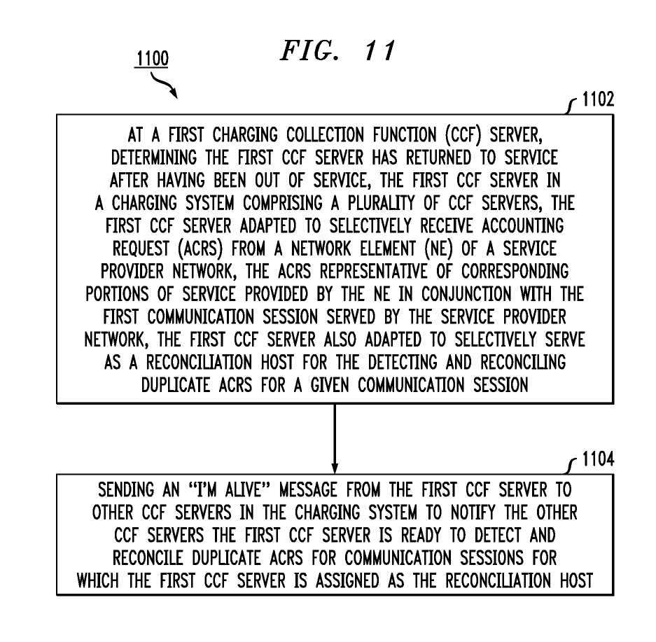

With reference to FIG. 11, another exemplary embodiment of a process 1100 for processing accounting requests in a charging system to account for service provided by a network element of a service provider network begins at 1102 where a first CCF server determines it has returned to service after having been out of service. The first CCF server being in a charging system comprising a plurality of CCF servers. The first CCF server adapted to selectively receive ACRs from a NE of a service provider network. The ACRs representative of corresponding portions of service provided by the NE in conjunction with a first communication session served by the service provider network. The first CCF server also adapted to selectively serve as a reconciliation host for detecting and reconciling duplicate ACRs for a given communication session. Next, an “I'm alive” message is sent from the first CCF server to other CCF servers in the charging system to notify the other CCF servers the first CCF server is ready to detect and reconcile duplicate ACRs for communication sessions for which the first CCF server is assigned as the reconciliation host (1104).

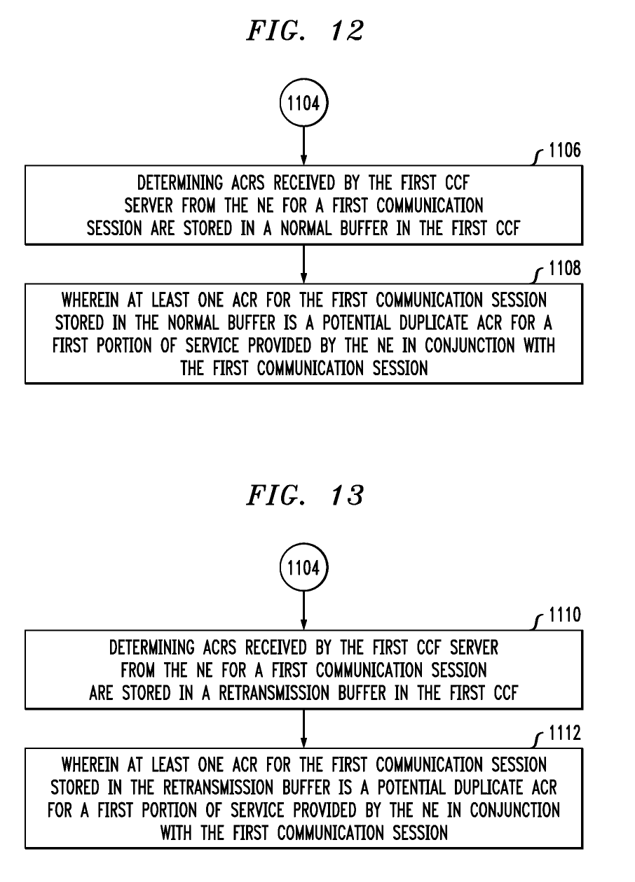

With reference to FIGS. 11 and 12, in yet another exemplary embodiment, the process 1100 includes determining ACRs received by the first CCF server from the NE for a first communication session are stored in a normal buffer in the first CCF (1106). At 1108, at least one ACR for the first communication session stored in the normal buffer is a potential duplicate ACR for a first portion of service provided by the NE in conjunction with the first communication session.

In a further embodiment, the process also includes determining a predetermined time has not elapsed since receiving and storing ACRs for the first communication session in the normal buffer. Then, the ACRs for the first communication session are moved from the normal buffer to a retransmission buffer in the first CCF server for subsequent detection and reconciliation of duplicate ACRs from the NE for the first communication session by the charging system.

In a still further embodiment, the process also includes determining a second CCF server from the plurality of CCF servers is acting as a primary reconciliation host for detecting and reconciling duplicate ACRs for the first communication session. Then, the ACRs for the first communication session stored in the retransmission buffer are sent to the second CCF server.

In an alternate still further embodiment, the process also includes determining the first CCF server is acting as a primary reconciliation host for detecting and reconciling duplicate ACRs for the first communication session.

In an alternate further embodiment, the process also includes determining a predetermined time has elapsed since receiving ACRs for the first communication session in the normal buffer. Then, the ACRs for the first communication session are moved from the normal buffer to a lost buffer in the first CCF server.

With reference to FIGS. 11 and 13, in still another exemplary embodiment, the process 1100 includes determining ACRs received by the first CCF server from the NE for a first communication session are stored in a retransmission buffer in the first CCF (1110). At 1112, at least one ACR for the first communication session stored in the retransmission buffer is a potential duplicate ACR for a first portion of service provided by the NE in conjunction with the first communication session.

In a further embodiment, the process also includes determining a predetermined time has not elapsed since receiving and storing ACRs for the first communication session in the retransmission buffer.

In a still further embodiment, the process also includes determining a second CCF server from the plurality of CCF servers is acting as a primary reconciliation host for detecting and reconciling duplicate ACRs for the first communication session. Then, the ACRs for the first communication session stored in the retransmission buffer are sent to the second CCF server.

In an alternate still further embodiment, the process also includes determining the first CCF server is acting as a primary reconciliation host for detecting and reconciling duplicate ACRs for the first communication session.

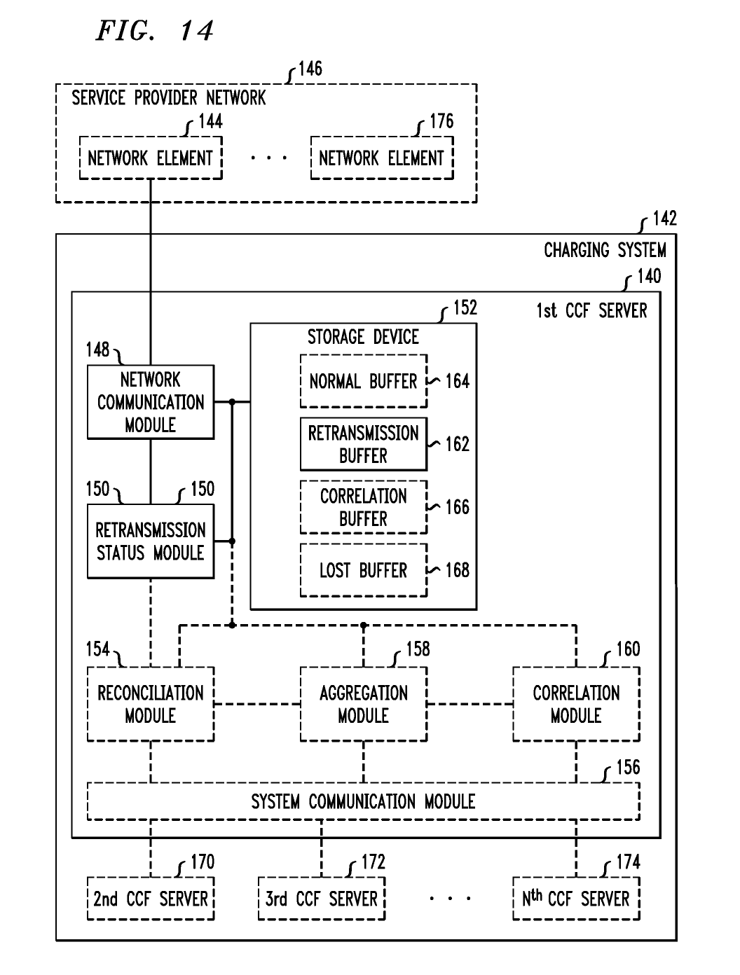

With reference to FIG. 14, an exemplary embodiment of a first CCF server 140 in a charging system 142 comprising a plurality of CCF servers is adapted to process ACRs to account for service provided by a NE 144 of a service provider network 146. The first CCF server 140 includes a network communication module 148, a retransmission status module 150, and a storage device 152. The first CCF server 140 may also include a reconciliation module 154, a system communication module 156, an aggregation module 158, and a correlation module 160. The storage device includes a retransmission buffer 162 and may also include a normal buffer 164, a correlation buffer 166, and a lost buffer 168. The charging system 142 also includes a second CCF server 170, a third CCF server 172, and other CCF servers 174. The service provider network 146 also includes other network elements 176.

The network communication module 148 receives a first ACR from a NE 144 of a service provider network 146. The first ACR being representative of a corresponding first portion of service provided by the NE 144 in conjunction with a communication session served by the service provider network 146. The retransmission status module 150 in operative communication with the network communication module 148 for determining the first ACR is a potential duplicate ACR for the first portion of service.

The storage device 152 in operative communication with the network communication module 148 and retransmission status module 150 for storing ACRs from the NE 144 for the communication session in the retransmission buffer 162 for subsequent detection and reconciliation of duplicate ACRs from the NE 144 for the communication session by the charging system 142.

In another embodiment of the first CCF server 140, the retransmission status module 150 determines a retransmit command flag in the first ACR indicates the first ACR is an initial transmission from the NE 144 for the first portion of service. In this embodiment, the storage device 152 includes a normal buffer 164 for storing ACRs from the NE for the communication session before the ACRs include a potential duplicate ACR. The storage device 152 stores ACRs from the NE 144 for the communication session in the normal buffer 164. In this embodiment, the retransmission status module 150 determines a subsequent ACR was not received from the NE 144 for the communication session within a predetermined time after a previous ACR from the NE 144 for the communication session. The predetermined time being greater than an expected time interval between time-based ACRs from the corresponding NE 144 for the communication session. The retransmission status module 150 moves ACRs from the NE 144 for the communication session from the normal buffer 164 to the retransmission buffer 162.

In yet another embodiment of the first CCF server 140, the retransmission status module 150 determines a retransmit command flag in the first ACR indicates the first ACR is a retransmission from the NE 144 for the first portion of service. In a further embodiment of the CCF server 140, the storage device 152 stores the first ACR and subsequent ACRs received from the NE 144 for the communication session in the retransmission buffer 162. In an alternate further embodiment of the CCF server 140, the retransmission status module 150 determines a subsequent ACR was not received from the NE 144 for the communication session within a predetermined time after a previous ACR from the NE 144 for the communication session. The predetermined time being greater than an expected time interval between time-based ACRs from the corresponding NE 144 for the communication session.

In still another embodiment, the first CCF server 140 includes the system communication module 156 and reconciliation module 154. The system communication module 156 for exchanging communications between the first CCF server 140 and other CCF servers (e.g., 170) in the charging system 142. The reconciliation module 154 in operative communication with the system communication module 156 and storage device 152 for determining a second CCF server 170 from the plurality of CCF servers is acting as a primary reconciliation host for detecting and reconciling duplicate ACRs for the communication session. The reconciliation module 154 sends the ACRs for the communication session stored in the retransmission buffer 162 to the second CCF server 170 via the system communication module 156.

In a further embodiment of the first CCF server 140, the reconciliation module 154 receives an acknowledgement message from the second CCF server 170 via the system communication module 156 acknowledging receipt of the ACRs sent to the second CCF server 170 for detection and reconciliation of duplicate ACRs. The reconciliation module 154 deletes the ACRs for the communication session stored in the retransmission buffer 162 in conjunction with receipt of the acknowledgement message from the second CCF server 170.

In an alternate further embodiment of the first CCF server 140, the reconciliation module 154 determines an acknowledgement message was not received from the second CCF server 170 via the system communication module 256 within a predetermined time after the ACRs were sent to the second CCF server 170 for detection and reconciliation of duplicate ACRs. In this embodiment, the reconciliation module 154 determines a third CCF server 172 from the plurality of CCF servers is acting as a secondary reconciliation host for detecting and reconciling duplicate ACRs for the communication session. The reconciliation module 154 sends the ACRs for the communication session stored in the retransmission buffer 162 to the third CCF server 172 via the system communication module 156.

In still yet another embodiment, the first CCF server 140 includes the system communication module 156 and reconciliation module 154. The system communication module 156 for exchanging communications between the first CCF server 140 and other CCF servers (e.g., 170) in the charging system (142). The reconciliation module 154 in operative communication with the system communication module 156 and storage device 152 for determining the first CCF server 140 is acting as a primary reconciliation host for detecting and reconciling duplicate ACRs for the communication session.

In a further embodiment of the first CCF server 140, the system communication module 156 receives ACRs from a second CCF server 170 of the plurality of CCF servers for detection and reconciliation of duplicate ACRs for the communication session by the reconciliation module 154. The ACRs from the second CCF server 170 originating from the NE 144 and associated with the communication session. The storage device 152 stores the ACRs from the second CCF server 170 in the retransmission buffer 162.

In a still further embodiment of the first CCF server 140, the reconciliation module 154 determines a start ACR and a stop ACR for the communication session are stored in the retransmission buffer 162. In this embodiment, the reconciliation module 154 determines if multiple ACRs for the communication session stored in the retransmission buffer are representative of the first portion of service provided by the NE 144. The reconciliation module 154 eliminates duplicate ACRs for the first portion of service from the retransmission buffer such that a single ACR representative of the first portion of service remains in the retransmission buffer 162.

In a still yet further embodiment, the first CCF server 140 also includes the aggregation module 158 and correlation module 160. The aggregation module 158 in operative communication with the reconciliation module 154 and storage device 152 for aggregating the ACRs for the communication session stored in the retransmission buffer 162 to form a charging data record (CDR) representative of service provided by the NE 144 for the communication session. The correlation module 160 in operative communication with the aggregation module 158 and system communication module 156 for determining a third CCF server 172 from the plurality of CCF servers is acting as a correlation host for correlating CDRs for the communication session. The correlation module 160 sends the CDR representative of service provided by the NE 144 for the communication session to the third CCF server 172 via the system communication module 156.

In an alternate still yet further embodiment, the first CCF server 140 also includes the aggregation module 158 and correlation module 160. The aggregation module 158 in operative communication with the reconciliation module 154 and storage device 152 for aggregating the ACRs for the communication session stored in the retransmission buffer 162 to form a CDR representative of service provided by the NE 144 for the communication session. The correlation module 160 in operative communication with the aggregation module 158 and storage device 152 for determining the first CCF server 140 is acting as a correlation host for correlating CDRs for the communication session. The storage device 152 includes a correlation buffer 166 for storing correlated CDRs and the storage device 152 stores the CDR representative of service provided by the NE 144 for the communication session in the correlation buffer 166.

In another further embodiment of the first CCF server 140, the retransmission status module 150 determines a predetermined time has elapsed since receiving ACRs for the communication session without having stored a start ACR and a stop ACR for the communication session in the retransmission buffer 162. The storage device 152 includes a lost buffer 168 for storing certain ACRs that are not aggregated or correlated in a normal manner and the storage device 152 moves the ACRs for the communication session from the retransmission buffer 162 to the lost buffer 168.

In yet another further embodiment of the first CCF server 140, the retransmission status module 150 determines a predetermined maximum fill factor for the retransmission buffer 162 has been exceeded without having stored a start ACR and a stop ACR for the communication session in the retransmission buffer 162. The storage device 152 includes a lost buffer 168 for storing certain ACRs that are not aggregated or correlated in a normal manner and the storage device 152 moves the ACRs for the communication session from the retransmission buffer 162 to the lost buffer 168.

In another embodiment of the first CCF server 140, the retransmission status module 150 determines a predetermined time has elapsed since receiving ACRs for the communication session in the retransmission buffer 162. The storage device 152 includes a lost buffer 168 for storing certain ACRs that are not aggregated or correlated in a normal manner and the storage device 152 moves the ACRs for the communication session from the retransmission buffer 162 to the lost buffer 168.

In yet another embodiment of the first CCF server 140, the retransmission status module 150 determines a predetermined maximum fill factor for the retransmission buffer 162 has been exceeded. The storage device 152 includes a lost buffer 168 for storing certain ACRs that are not aggregated or correlated in a normal manner and the storage device 152 moves the ACRs for the communication session from the retransmission buffer 162 to the lost buffer 168.

In still yet another embodiment of the first CCF server 140, the retransmission status module 150 determines the first CCF server 140 has returned to service after having been out of service. In this embodiment, the first CCF server 140 also include the system communication module 156 and reconciliation module 154. The system communication module 156 for exchanging communications between the first CCF server 140 and other CCF servers in the charging system 142. The reconciliation module 154 in operative communication with the system communication module 156 and storage device 152 such that the first CCF server 140 can selectively serve as a reconciliation host for detecting and reconciling duplicate ACRs for the communication session. The reconciliation module 154 sends an “I'm alive” message to other CCF servers (e.g., 170) in the charging system 142 via the system communication module 156 to notify the other CCF servers the first CCF server 140 is ready to detect and reconcile duplicate ACRs for communication sessions for which the first CCF server 140 is assigned as the reconciliation host.

In a further embodiment of the first CCF server 140, the storage device 152 includes a normal buffer 164 for storing ACRs from the NE 144 for the communication session before the ACRs include a potential duplicate ACR and the retransmission status module 150 determines ACRs received from the NE 144 for the communication session are stored in the normal buffer 164. At this point, at least one ACR for the communication session stored in the normal buffer 164 is a potential duplicate ACR for the first portion of service provided by the NE 144 in conjunction with the communication session.

In a still further embodiment of the first CCF server 140, the retransmission status module 150 determines a predetermined time has not elapsed since receiving and storing ACRs for the communication session in the normal buffer 164. The retransmission status module 150 moves the ACRs for the communication session from the normal buffer 164 to the retransmission buffer for subsequent detection and reconciliation of duplicate ACRs from the NE for the communication session by the charging system.

In a yet still further embodiment of the first CCF server 140, the reconciliation module 154 determines a second CCF server 170 from the plurality of CCF servers is acting as a primary reconciliation host for detecting and reconciling duplicate ACRs for the communication session. The reconciliation module 154 sends the ACRs for the communication session stored in the retransmission buffer 162 to the second CCF server 170.

In an alternate yet still further embodiment of the first CCF server 140, the reconciliation module 154 determines the first CCF server 140 is acting as a primary reconciliation host for detecting and reconciling duplicate ACRs for the communication session.

In an alternate still further embodiment of the first CCF server 140, the retransmission status module 150 determines a predetermined time has elapsed since receiving ACRs for the communication session in the normal buffer 164. The storage device 152 includes a lost buffer 168 for storing certain ACRs that are not aggregated or correlated in a normal manner and the storage device 152 moves the ACRs for the communication session from the normal buffer 164 to the lost buffer 168.

In an alternate further embodiment of the first CCF server 140, the retransmission status module 150 determines ACRs received from the NE 144 for the communication session are stored in the retransmission buffer 162. In this embodiment, at least one ACR for the communication session stored in the retransmission buffer 162 is a potential duplicate ACR for a first portion of service provided by the NE 144 in conjunction with the communication session.

In a still further embodiment of the first CCF server 140, the retransmission status module 150 determines a predetermined time has not elapsed since receiving and storing ACRs for the communication session in the retransmission buffer 162.

In a yet still further embodiment of the first CCF server 140, the reconciliation module 154 determines a second CCF server 170 from the plurality of CCF servers is acting as a primary reconciliation host for detecting and reconciling duplicate ACRs for the communication session. The reconciliation module 154 sends the ACRs for the communication session stored in the retransmission buffer 162 to the second CCF server 170.

In an alternate yet still further embodiment of the first CCF server 140, the reconciliation module 154 determines the first CCF server 140 is acting as a primary reconciliation host for detecting and reconciling duplicate ACRs for the communication session.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for processing accounting requests in a charging system to account for service provided by a network element of a service provider network, comprising:
a) receiving a first accounting request (ACR) from a network element (NE) at a first charging collection function (CCF) server, the NE being in a service provider network, the first CCF server in a charging system comprising a plurality of CCF servers, the first ACR representative of a corresponding first portion of service provided by the NE in conjunction with a communication session served by the service provider network;
b) determining the first ACR is a potential duplicate ACR for the first portion of service; and
c) storing ACRs received by the first CCF server from the NE for the communication session in a retransmission buffer in the first CCF server for subsequent detection and reconciliation of duplicate ACRs from the NE for the communication session by the charging system.

2. The method set forth in claim 1, the determining in b) comprising:
d) determining a retransmit command flag in the first ACR indicates the first ACR is an initial transmission from the NE for the first portion of service;
e) storing ACRs received by the first CCF server from the NE for the communication session in a normal buffer in the first CCF server;
f) determining a subsequent ACR was not received from the NE for the communication session within a predetermined time after a previous ACR from the NE for the communication session, the predetermined time being greater than an expected time interval between time-based ACRs from the NE for the communication session; and
g) the storing in c) comprising moving ACRs from the NE for the communication session from the normal buffer to the retransmission buffer.

3. The method set forth in claim 1, the determining in b) comprising:
d) determining a retransmit command flag in the first ACR indicates the first ACR is a retransmission from the NE for the first portion of service.

4. The method set forth in claim 1, further comprising:
d) determining a second CCF server from the plurality of CCF servers is acting as a primary reconciliation host for detecting and reconciling duplicate ACRs for the communication session; and
e) sending the ACRs for the communication session stored in the retransmission buffer to the second CCF server.

5. The method set forth in claim 1, further comprising:
d) determining the first CCF server is acting as a primary reconciliation host for detecting and reconciling duplicate ACRs for the communication session.

6. The method set forth in claim 5, further comprising:
e) receiving ACRs from a second CCF server of the plurality of CCF servers for detection and reconciliation of duplicate ACRs for the communication session at the first CCF server, the ACRs from the second CCF server originating from the NE and associated with the communication session; and
f) storing the ACRs from the second CCF server in the retransmission buffer.

7. The method set forth in claim 6, further comprising:
g) determining a start ACR and a stop ACR for the communication session are stored in the retransmission buffer;
h) determining if multiple ACRs for the communication session stored in the retransmission buffer are representative of the first portion of service provided by the NE; and
i) eliminating duplicate ACRs for the first portion of service from the retransmission buffer such that a single ACR representative of the first portion of service remains in the retransmission buffer.

8. The method set forth in claim 1, further comprising:
d) determining a predetermined time has elapsed since receiving ACRs for the communication session in the retransmission buffer; and
e) moving the ACRs for the communication session from the retransmission buffer to a lost buffer in the first CCF server.

9. The method set forth in claim 1, further comprising:
d) determining a predetermined maximum fill factor for the retransmission buffer has been exceeded; and
e) moving the ACRs for the communication session from the retransmission buffer to a lost buffer in the first CCF server.

10. A method for processing accounting requests in a charging system to account for service provided by a network element of a service provider network, comprising:
a) at a first charging collection function (CCF) server, determining the first CCF server has returned to service after having been out of service, the first CCF server in a charging system comprising a plurality of CCF servers, the first CCF server adapted to selectively receive accounting requests (ACRs) from a network element (NE) of a service provider network, the ACRs representative of corresponding portions of service provided by the NE in conjunction with a first communication session served by the service provider network, the first CCF server also adapted to selectively serve as a reconciliation host for detecting and reconciling duplicate ACRs for a given communication session; and
b) sending an “I'm alive” message from the first CCF server to other CCF servers in the charging system to notify the other CCF servers the first CCF server is ready to detect and reconcile duplicate ACRs for communication sessions for which the first CCF server is assigned as the reconciliation host.

11. The method set forth in claim 10, further comprising:
c) determining ACRs received by the first CCF server from the NE for a communication session are stored in a normal buffer in the first CCF;
wherein at least one ACR for the first communication session stored in the normal buffer is a potential duplicate ACR for a first portion of service provided by the NE in conjunction with the first communication session.

12. The method set forth in claim 11, further comprising:
d) determining a predetermined time has not elapsed since receiving and storing ACRs for the first communication session in the normal buffer; and
e) moving the ACRs for the first communication session from the normal buffer to a retransmission buffer in the first CCF server for subsequent detection and reconciliation of duplicate ACRs from the NE for the first communication session by the charging system.

13. The method set forth in claim 12, further comprising:
f) determining a second CCF server from the plurality of CCF servers is acting as a primary reconciliation host for detecting and reconciling duplicate ACRs for the first communication session; and
g) sending the ACRs for the first communication session stored in the retransmission buffer to the second CCF server.

14. The method set forth in claim 12, further comprising:
f) determining the first CCF server is acting as a primary reconciliation host for detecting and reconciling duplicate ACRs for the first communication session.

15. The method set forth in claim 11, further comprising:
d) determining a predetermined time has elapsed since receiving ACRs for the first communication session in the normal buffer; and
e) moving the ACRs for the first communication session from the normal buffer to a lost buffer in the first CCF server.

16. The method set forth in claim 10, further comprising:
c) determining ACRs received by the first CCF server from the NE for a first communication session are stored in a retransmission buffer in the first CCF;
wherein at least one ACR for the first communication session stored in the retransmission buffer is a potential duplicate ACR for a first portion of service provided by the NE in conjunction with the first communication session.

17. The method set forth in claim 16, further comprising:
d) determining a predetermined time has not elapsed since receiving and storing ACRs for the first communication session in the retransmission buffer.

18. The method set forth in claim 17, further comprising:
e) determining a second CCF server from the plurality of CCF servers is acting as a primary reconciliation host for detecting and reconciling duplicate ACRs for the first communication session; and
f) sending the ACRs for the first communication session stored in the retransmission buffer to the second CCF server.

19. The method set forth in claim 17, further comprising:
e) determining the first CCF server is acting as a primary reconciliation host for detecting and reconciling duplicate ACRs for the first communication session.

20. A first charging collection function (CCF) server in a charging system comprising a plurality of CCF servers, the first CCF server for processing accounting requests in the charging system to account for service provided by a network element of a service provider network, the first CCF server comprising:
a network communication module for receiving a first accounting request (ACR) from a network element (NE) of a service provider network, the first ACR representative of a corresponding first portion of service provided by the NE in conjunction with a communication session served by the service provider network;
a retransmission status module in operative communication with the network communication module for determining the first ACR is a potential duplicate ACR for the first portion of service; and
a storage device in operative communication with the network communication module and retransmission status module for storing ACRs from the NE for the communication session in a retransmission buffer for subsequent detection and reconciliation of duplicate ACRs from the NE for the communication session by the charging system.

21. The first CCF server set forth in claim 20, further comprising:
a system communication module for exchanging communications between the first CCF server and other CCF servers in the charging system; and
a reconciliation module in operative communication with the system communication module and storage device for determining a second CCF server from the plurality of CCF servers is acting as a primary reconciliation host for detecting and reconciling duplicate ACRs for the communication session;
wherein the reconciliation module sends the ACRs for the communication session stored in the retransmission buffer to the second CCF server via the system communication module.

22. The first CCF server set forth in claim 20, further comprising:
a system communication module for exchanging communications between the first CCF server and other CCF servers in the charging system; and
a reconciliation module in operative communication with the system communication module and storage device for determining the first CCF server is acting as a primary reconciliation host for detecting and reconciling duplicate ACRs for the communication session.

23. The first CCF server set forth in claim 22 wherein the system communication module receives ACRs from a second CCF server of the plurality of CCF servers for detection and reconciliation of duplicate ACRs for the communication session by the reconciliation module, the ACRs from the second CCF server originating from the NE and associated with the communication session;
wherein the storage device stores the ACRs from the second CCF server in the retransmission buffer;
wherein the reconciliation module determines a start ACR and a stop ACR for the communication session are stored in the retransmission buffer;
wherein the reconciliation module determines if multiple ACRs for the communication session stored in the retransmission buffer are representative of the first portion of service provided by the NE;
wherein the reconciliation module eliminates duplicate ACRs for the first portion of service from the retransmission buffer such that a single ACR representative of the first portion of service remains in the retransmission buffer.

24. The first CCF server set forth in claim 23, further comprising:
an aggregation module in operative communication with the reconciliation module and storage device for aggregating the ACRs for the communication session stored in the retransmission buffer to form a charging data record (CDR) representative of service provided by the NE for the communication session; and
a correlation module in operative communication with the aggregation module and system communication module for determining a third CCF server from the plurality of CCF servers is acting as a correlation host for correlating CDRs for the communication session;
wherein the correlation module sends the CDR representative of service provided by the NE for the communication session to the third CCF server via the system communication module.

25. The first CCF server set forth in claim 23, further comprising:
an aggregation module in operative communication with the reconciliation module and storage device for aggregating the ACRs for the communication session stored in the retransmission buffer to form a charging data record (CDR) representative of service provided by the NE for the communication session; and
a correlation module in operative communication with the aggregation module and storage device for determining the first CCF server is acting as a correlation host for correlating CDRs for the communication session;
wherein the storage device includes a correlation buffer for storing correlated CDRs and the storage device stores the CDR representative of service provided by the NE for the communication session in the correlation buffer.

26. The first CCF server set forth in claim 20 wherein the retransmission status module determines the first CCF server has returned to service after having been out of service, the first CCF server further comprising:
a system communication module for exchanging communications between the first CCF server and other CCF servers in the charging system; and
a reconciliation module in operative communication with the system communication module and storage device such that the first CCF server can selectively serve as a reconciliation host for detecting and reconciling duplicate ACRs for the communication session;
wherein the reconciliation module sends an “I'm alive” message to other CCF servers in the charging system via the system communication module to notify the other CCF servers the first CCF server is ready to detect and reconcile duplicate ACRs for communication sessions for which the first CCF server is assigned as the reconciliation host.

27. The first CCF server set forth in claim 26 wherein the storage device includes a normal buffer for storing ACRs from the NE for the communication session before the ACRs include a potential duplicate ACR and the retransmission status module determines ACRs received from the NE for the communication session are stored in the normal buffer;
wherein at least one ACR for the communication session stored in the normal buffer is a potential duplicate ACR for the first portion of service provided by the NE in conjunction with the communication session.

28. The first CCF server set forth in claim 26 wherein the retransmission status module determines ACRs received from the NE for the communication session are stored in the retransmission buffer;
wherein at least one ACR for the communication session stored in the retransmission buffer is a potential duplicate ACR for a first portion of service provided by the NE in conjunction with the communication session.
